(19) United States
(12) Patent Application Publication
(10) Pub. No.: US 2004/0153787 A1
(43) Pub. Date: Aug. 5, 2004

(54) Process for managing messages between a set of decoders and a system of conditional access control

(76) Inventor: Eric Zucker, Etoy (CH)

Correspondence Address: HARNESS, DICKEY & PIERCE, P.L.C., P.O. BOX 8910, RESTON, VA, 20195, US

(21) Appl. No.: 10/681,256

(22) Filed: Oct. 9, 2003

(30) Foreign Application Priority Data
Oct. 11, 2002 (CH) 1689/02

(51) Int. Cl. H04L 1/22

(52) U.S. Cl. 714/25

(57) ABSTRACT

In this process, the messages coming from the decoders are separated in packets. The packets of single message are sequentially processed in the access control system and the packets coming from different messages are processed concurrently. The system includes at least one module for processing message packets, each module giving on the one hand a message processed by said module and on the other hand service data related to the processing of said message packet. The process consists in introducing the packets of each message in at least one of the processing modules; processing, in each processing module, each message packet; collecting the service data of each processing module related to each message packet; organizing the service data collected according to a predetermined order; verifying if one of the packets has generated a processing error; grouping together in a first memory zone, called detailed memory, the service data of the messages for which at least one packet from the processing packets has generated an error; generating a receipt for all the messages for which the processing packets have not generated any error; grouping together in a second memory zone, called abstract memory, the receipts of messages without any error.

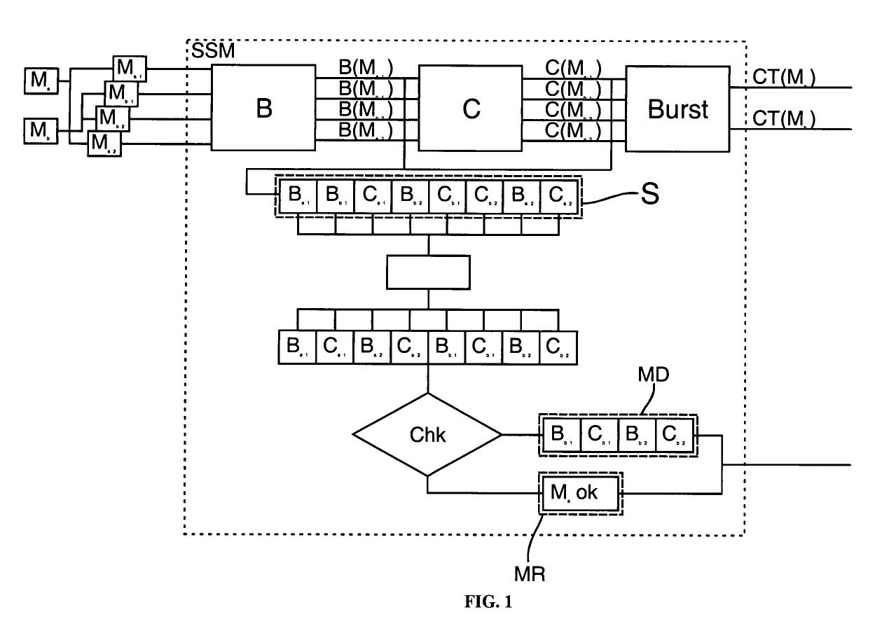

The present invention concerns a process for managing messages between a set of decoders and an access control system, especially in the field of the Pay-TV.

In some configurations of access control systems to a Pay-TV programme or under conditional access, the decoders used to decipher or descramble the programs communicate with the system of conditional access control by means of a return line that can be a phone line or a cable connection. These communications pass in transit through a communications management system between the access control system and the decoders connected to this system. Such a system is known under the SSM acronym (Subscriber Session Manager) and contains a certain number of modules, each of them having a particular function.

Each module processes alternately the message from the decoders and passes the processed contents on to the following module. During this processing, each module gives a certain number of “service data” such as the processing starting and ending time, the processing length, the relevant decoder number, the input and output data, the processing success or failure.

Each communication contains one or more messages and each message can be made up of several packets. The SSM manages simultaneously many communications, while all the packets of a message are not processed consecutively. On the contrary, the packets of the different messages are processed in a mixed order.

The service data are displayed as the packets are processed. A file containing the service data of each module, for each packet is generated. This file is used for diagnosis in case of anomalies during a communication. When an error occurs during a communication, it is necessary to search in this file all the data related to this communication. Due to the quantity of modules, of the service data for each module and of the message packets for each communication, this search work can be very fastidious.

A parameter can be modified. It's the verbosity level of the modules, that is the number of service data released by each module. The greatest the verbosity level, the more detailed data allowing anomalies detection will be, but it will be more difficult to detect them in the file. The weaker the verbosity level, the easier it will be to find in the file the data related to a communication, but the data related to an anomaly will be less detailed, with the risk that the details level will not be sufficient to detect the source of an anomaly and thus to correct it.

It is thus necessary to find a compromise solution between the file size and the verbosity level that one wishes to obtain or is able to manage.

This invention intends to compensate for the drawbacks of the prior art processes, by carrying out a process in which the verbosity level can be maintained to a high level but without ending up to a large file difficult to use.

This aim is reached by a process for managing messages between a decoder set and a system of conditional access control, in which the messages coming from the decoders are separated in packets, the packets of a same message being sequentially processed in the access control system, the packets coming from different messages being processed concurrently, this system including at least one module for processing the messages packets, each module giving on the one hand a message processed by said module and on the other hand service data related to the processing of said message packet, the process consisting in:

introducing the packets of each message in at least one of the processing modules,

processing, in each processing module, each message packet,

collecting the service data of each processing module related to each message packet,

organizing the service data collected according to a predetermined order,

verifying if one of the packets has generated a processing error,

grouping together in a first memory zone, called detailed memory, the service data of the messages for which at least one packet from the processing packets has generated an error,

generating a receipt for all the messages for which the processing packets have not generated any error,

grouping together in a second memory zone, called abstract memory, the receipts of messages without any error.

This invention and its advantages will be better understood with reference to the description of a particular embodiment of the invention and to the annexed design in which single FIGURE represents schematically a device for the implementation of the process according to the invention.

This FIGURE represents more particularly the invention process, in which two messages Mₐ and M_{b} are transmitted, each message including two packets having respectively the subscripts 1 and 2 (Mₐ₁, Mₐ₂, M_{b1}, M_{b2}).

The SSM includes three modules, namely two processing modules, B and C, and a concatenation module (Burst) which has the function of grouping together the packets belonging to a same message, so that to each Mₐ, M_{b} input message would correspond an output message CT(Mₐ), CT(M_{b}).

The process according to the invention takes place as follows:

The messages to be transmitted Ma are first separated in packets (Mₐ₁, Mₐ₂, M_{b1}, M_{b2}). These messages are introduced in the SSM, according to a mixed order, which meets some criteria. In particular, Mₐ₂ is introduced after Mₐ₁; similarly, M_{b2} is introduced after M_{b1}, but the order between Mₐ and M_{b} is indifferent.

Each message packet is then introduced in the first processing module B. Two data types come out of this module. On the one hand it concerns the contents of each message packet as processed by the module B, pointed out B(Mₐ), B(M_{b}) in the FIGURE, and on the other hand, service data relating to this module B. These can for example contain the processing starting and ending time of the packet Mₐ₁, a decoder number associated with the message Mₐ, an indication of whether the processing is spoilt of an anomaly or not, or any further useful piece of information for error detection or anomalies in messages transmission.

The service data of the module B are referenced in FIGURE as Bₐ₁, Bₐ₂, B_{b1}, B_{b2}.

Each message packet coming out from the first module B is introduced into a second module C. In a similar way as processing in B, C carries out a certain number of operations on each packet and releases on the one hand processed contents (C(Mₐ₁), C(Mₐ₂), . . . ) and on the other hand service data Cₐ₁, Cₐ₂. The packets processed by this second module are introduced in a concatenation module (Burst) which has as objective to group together the different parts of each message, by gathering the corresponding packets, so that complete messages CT(Mₐ), CT(M_{b}) . . . can be delivered and not in packet form anymore.

The messages coming from this concatenation module are processed as known to those skilled in the art, according to their use, namely that they are notably stored in a database.

The service data coming from the modules B and C are generally mixed. In fact, on the basis of the operations to be carried out, it is possible for the processing of the packet Mₐ₁ in the second module C to be terminated before that of packet M_{b2} in the first module B. This is especially true since in the imaginary described example, the SSM only includes two modules processing and only two messages are processed. In practice, the number of modules can reach about ten and there can be several dozens, even hundreds messages.

In the devices of the prior art, the service data is obtained in the output order, as previously mentioned.

In the device according to the invention, a buffer memory S stores the service data. These are then serialized in a grouping module R so that the service data relating to the packets of a message are grouped together.

This grouping can be done in different ways, one of these being that all the data relating to a packet is grouped in the order of the modules.

When this serialization operation is completed, it is easy to determine blocks relating to a given message Mₐ, M_{b}. The blocks' size depends on the number of service data for each module, on the number of packets per message and on the number of modules.

For each block, a check is carried out in a module indicated as Chk in FIGURE. The aim of this verification is to determine if the message has passed without any error or if on the contrary an anomaly occurred.

In the FIGURE, it is supposed that the message Mₐ has passed without any error while M_{b} has met an error.

The device contains two memories areas, one abstract memory referenced MR and one detailed memory referenced MD. When the message has passed without any error, as for the message Mₐ, the service data of each module is for the most part unnecessary. Only a receipt related to this message Mₐ is introduced in the abstract memory MR. This receipt can contain service data with a very limited verbosity level. This information can for example simply contain a decoder number, an indication of the transmitted message contents, a date and a time.

The second detailed memory area, MD contains service data related to the messages whose transmission has been spoilt by mistakes. In this case, the verbosity level is high and is defined so that it is possible to detect the errors sources and reasons.

The contents of these two memory areas MR and MD form a file that can be displayed and processed by a user. However, unlike the files of the prior art devices, this one does not contain unnecessary data on the one hand. In fact, all the communications, which have passed without any error, are represented by a simple receipt and not by a vast number of service data.

On the other hand, the service data coming from messages spoilt of mistakes is listed in a given order, in block form, which only contains the data related to this message.

Therefore, the error search can be done in a very simplified way, still maintaining a verbosity level as high as desired by the user. It should be noted that this process can be used, as described, when the processing modules are set in series. However, it could also be used for a processing by modules set in parallel.

1. Process for managing messages between a decoder set and a system of conditional access control, in which the messages coming from the decoders are separated in packets, the packets of a same message being sequentially processed in the access control system, the packets coming from different messages being processed concurrently, this system including at least one module for processing the messages packets, each module giving on the one hand a message processed by said module and on the other hand service data related to the processing of said message packet, the process consisting in:
introducing the packets of each message in at least one of the processing modules,
processing, in each processing module, each message packet,
collecting the service data of each processing module related to each message packet,
organizing the service data collected according to a predetermined order,
verifying if one of the packets has generated a processing error,
grouping together in a first memory zone, called detailed memory, the service data of the messages for which at least one packet from the processing packets has generated an error,
generating a receipt for all the messages for which the processing packets have not generated any error,
grouping together in a second memory zone, called abstract memory, the receipts of messages without any error.

2. Process for managing messages according to claim 1, characterized in that the processing modules are set at least partially in series.

3. Process for managing messages according to claim 1, characterized in that the processing modules are set at least partially in parallel.
